(19) United States
(12) Patent Application Publication
(10) Pub. No.: US 2004/0147302 A1
(43) Pub. Date: Jul. 29, 2004

(54) Methods for playing video poker

(76) Inventor: Max Stern, Las Vegas, NV (US)

Correspondence Address: Jeffrey C. Maynard, 154 Barbara Road, Severna Park, MD, 21146, US

(21) Appl. No.: 10/724,447

(22) Filed: Nov. 28, 2003

Related U.S. Application Data
(60) Provisional application No. 60/429,497, filed on Nov. 27, 2002.

(51) Int. Cl. A63F 13/00

(52) U.S. Cl. 463/13

(57) ABSTRACT

A method and apparatus for playing a slot machine game. All the possible ‘hands’ for a cycle are generated and stored in a database. One ‘hand is randomly selected for display until all ‘hands’ in the cycle are displayed. A prize is awarded to the player, in the event such ‘hand’ qualifies as a winning combination according to a predetermined table of values.

### CROSS REFERENCE TO RELATED APPLICATION

This Application claims the benefit of U.S. Provisional Application, Serial No. 60/429,497 entitled Methods for Playing Video Poker, filed with the U.S. Patent and Trademark Office on Nov. 27, 2002 by the inventor herein.

### BACKGROUND OF THE INVENTION

1. Field of the Invention

The present invention relates to gaming machines of the type generally referred to as slot machines, and in particular, the invention provides an improvement to a game played on such a machine. This invention relates generally to games of chance such as would be found in casinos and other legal gambling establishments and more particularly to electronic gaming systems that can be used to play video poker. The game is enabled, in particular, for video gambling machines, computer games, or other electronic devices.

2. Background of the Prior Art

In the gaming business there are two kinds of games; one in which the results depend solely on luck, and another in which the results depend on the skill of the players. Examples of games depending solely on luck include basic slot machines, roulette, and craps. Examples of games depending on the players' skill include draw poker and blackjack.

Although, the gaming industry has undergone a significant expansion in recent years, the most popular form of gaming continues to be centered about slot machines. They account for approximately three-fourths of the total volume of all gambling activities in the United States. Because of the volume of slot machine gaming, numerous devices, rules, and methods of operation have been proposed and introduced in efforts to improve the games.

Over the years and in keeping with the changes in technology, slot machines have evolved from purely mechanical devices, through electromechanical devices to present day electronic slot machines, most of which are controlled entirely by computer. Most present day slot machines have a video screen to display symbols based on graphic data stored in memory associated with a computer processor.

Electronic video poker games have been prevalent in gaming casinos for many years. The electronic video poker gaming machine is designed to replicate the play of a ‘hand’ of poker. Typically, a player is not playing against any other players or against a dealer's hand; the player is simply attempting to achieve the highest-ranking poker ‘hand’ possible from the cards displayed to the player.

Video poker is generally played on an electronic video gaming machine that uses a video screen display to show images of cards to a player. Computer controls carried on a printed circuit board mounted on the interior of the gaming machine electronically shuffle the deck of cards, activate the dealing sequence in response to input by a player, cause the cards to be displayed on the video screen display, and analyze the ‘hand’ to determine winning and losing combinations. The computer controls also affect payouts to the player based on the amount of the player's wager and the poker ranking of the ‘hand’.

The higher the poker ‘hand’ achieved by the player, the greater the player's winnings based on the number of coins, tokens or credits wagered by the player. Typically, a payout schedule is posted on the gaming machine to advise the player of the payoffs available for certain winning card combinations.

Nevertheless, players have become bored with traditional video games. Players prefer to play machines that have pay tables with high payouts for the types of winning combinations that are achievable. With the growth that has occurred in the gaming machine market, there is intense competition among manufacturers to supply the existing and new venues. Gaming casino operators are desirous of having different types of electronic video games to offer to players. When selecting a supplier of gaming machines, the operator of a venue will often pay close attention to the popularity of various games with their patrons. Therefore, gaming machine manufacturers are keen to devise games, which are popular with players, as a mechanism for improving sales.

The laws and regulations in some states that allow slot machine wagering and in particular, some Native American casinos, nevertheless, do not permit strictly random presentation of playing elements. That is, a fixed, albeit large, number of permutations make up the possible combination of playing elements for various games. Each possible combination must be played before any one combination can be repeated. For example, in a game utilizing a single deck of cards to deal five cards to a player, only a finite number of different ‘hands’ can be dealt. The total number of different ‘hands’ is dealt in one cycle. The cycle must be complete before any ‘hand’ can be repeated. In an electronic gaming machine, the controller software generates all the possible ‘hands’ for a cycle and stores such ‘hands’ in a database. The machine controls the game so that a ‘hand’ is randomly selected from all the possible ‘hands’ in the database. Once a ‘hand’ is played, it is removed from the database. Additional ‘hands’ are then played until all the ‘hands’ in the database have been played, which completes the cycle. After all ‘hands’ have been played, the software then generates all the possible ‘hands’ again to refill the database for further play.

Despite numerous improvements in the quality and variety of gaming machines made over the years, there remains a need for improved game machines and methods that provide more attractive machine play and associated entertainment. Although there have been attempts to improve upon existing games and to develop new games of chance, there exists a need for a game that more closely meets the player's needs for excitement, risk, quickly and easily understood play, and possibility of success. At the same time, the game must meet the casinos' prerequisite for profitability from the use of the game.

A need exists for a wagering game that is intended to be played in gambling casinos, that is simple to learn and play, and that guarantees that every possible ‘hand’ will be shown in a cycle. There is a need for new video gaming machines that are capable of encouraging a high volume of play while at the same time offering what the players consider to be good pay tables. Furthermore, there is a need to provide new and interesting electronic video games that attract players and that can increase the volume of wagering in each gaming machine.

### SUMMARY OF THE INVENTION

The present invention fulfills these needs. It is a fast-paced game of simple consistent rules, player participation, choice of risk offered by a variety of games, and corresponding to varying payout. The house edge is fairly derived and players will detect this fairness through the payout odds. These features will increase the number of players to the game, both experienced and inexperienced players, generating player satisfaction and profitability to the casino.

An object of the present invention is straightforward entertainment with some of the atmosphere of a casino. A related object of the present invention is to provide an enjoyable gambling game.

It is a further object of the present invention to provide a game that will be easy for players to learn.

Another object is to provide visible winning results promptly, solely for entertainment purposes, or additionally for wagering, such that a casino atmosphere of chance is available for a single participant.

It is a still further object of the invention to provide a video gaming machine apparatus, which displays a new and interesting game that encourages a high amount of individual player interest while maintaining acceptable payback percentages.

Yet another object is to provide an electronic gaming system that presents every possible ‘hand’ in a cycle. A related object is to provide an electronic gaming system in which every possible ‘hand’ is played before a new cycle begins.

A further object of the present invention is to enable adaptation of the invention to usage independent of a gaming establishment, including individual personal usage.

According to a first aspect, the present invention provides a video gaming machine including display means arranged to display a game being played on the machine, game initiating means to initiate a game on the machine and game control means responsive to the initiating means to control the playing of the game, characterized in that the game enables a player to play a game based solely on luck, the display means is arranged to display a plurality of indicia in a first set being associated with random elements according to a selected game, the control means determines all the possible ‘hands’ for a cycle, randomly selects a ‘hand’ for display until all ‘hands’ in the cycle are displayed, and awards a prize to the player, in the event such indicia qualifies as a winning ‘hand’ according to a predetermined table of values.

Whether solely for amusement or for entertainment with wagering, an electronic video game machine can be used. Such ‘hand’ can be displayed in an electronic game machine apparatus.

The various features of novelty that characterize the invention will be pointed out with particularity in the claims of this application.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is an illustration of a slot machine incorporating the present invention.

FIG. 2 is a block diagram illustration of processing components for performing functions according to the present invention.

FIG. 3 is a flow chart illustrating steps of a specific embodiment of the invention.

FIG. 4 shows a front elevational view of an electronic video gaming machine screen display for describing specific steps of one embodiment of the present invention.

FIG. 5 shows a front elevational view of an electronic video gaming machine screen display for describing an alternate embodiment of the present invention.

FIG. 6 is a schematic diagram of a slot machine control circuit according to the present invention.

### DETAILED DESCRIPTION OF THE INVENTION

The invention summarized above and defined by the enumerated claims may be better understood by referring to the following detailed description, which should be read in conjunction with the accompanying drawings in which like reference numbers are used for like parts. This detailed description of an embodiment, set out below to enable one to build and use an implementation of the invention, is not intended to limit the enumerated claims, but to serve as a particular example thereof. Those skilled in the art should appreciate that they may readily use the conception and specific embodiment disclosed as a basis for modifying or designing other methods and systems for carrying out the same purposes of the present invention. Those skilled in the art should also realize that such equivalent assemblies do not depart from the spirit and scope of the invention in its broadest form.

In the following detailed description, the methodology of the embodiment will be described and it is to be understood that it is within the capabilities of a non-inventive worker in the art to introduce the methodology on any standard microprocessor based gaming machine by means of appropriate programming.

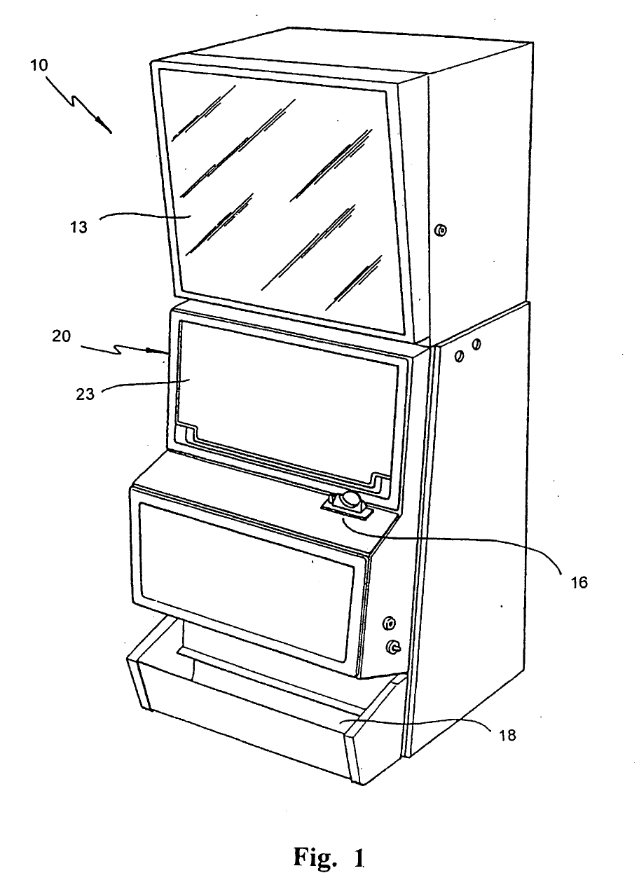

Referring to FIG. 1, the illustrated embodiment of the invention is housed in a cabinet 10 including a decorative panel 13 for displaying advertising, a trademark, a decorative picture, a brief description of game instructions, and the like. A coin entry slot 16 is provided to receive coins, tokens or game chips (hereinafter coins) for wagering on a play of the game. A payout tray or coin hopper 18 is disposed on the front of cabinet 10 for holding coins dispensed in the course of a game.

Preferably, a game display means comprises a video display screen 20 controlled to display indicia images as described later herein. The video screen is preferably of the touch sensitive variety, having a touch sensitive input area 23 located on its display surface on which player selections for play of the game described herein are to be made.

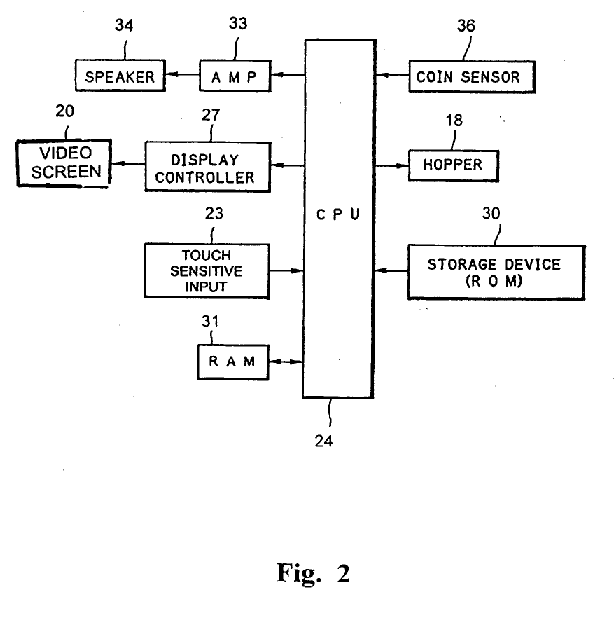

Referring to FIG. 2, a block diagram illustration of processing components for performing functions according to the present invention is shown. A central processing unit (CPU) 24 is connected to touch sensitive input area 23 for receiving player input. The central processing unit 24 receives player input and controls the play of the game. CPU 24 also controls the display of images (characters, numbers, and symbols) on video screen 20 to operate each unit. A display controller 27 controls the display of images to video screen 20.

A storage device 30 is constituted of a ROM, a hard disk, or the like, and stores a program for playing a slot machine game, symbol patterns of each playing element, and the like. RAM 31 is used for storing data input from the touch sensitive input 23, such as a score list indicating the contents of played games, the number of credited coins, and the like.

In an alternate embodiment, an amplifier 33 drives speaker 34 for generating sounds to resemble shuffling cards, to highlight game result conditions, game termination, and the like.

A coin sensor 36 detects a coin inserted into the coin entry slot 16. The hopper 18 ejects credited coins.

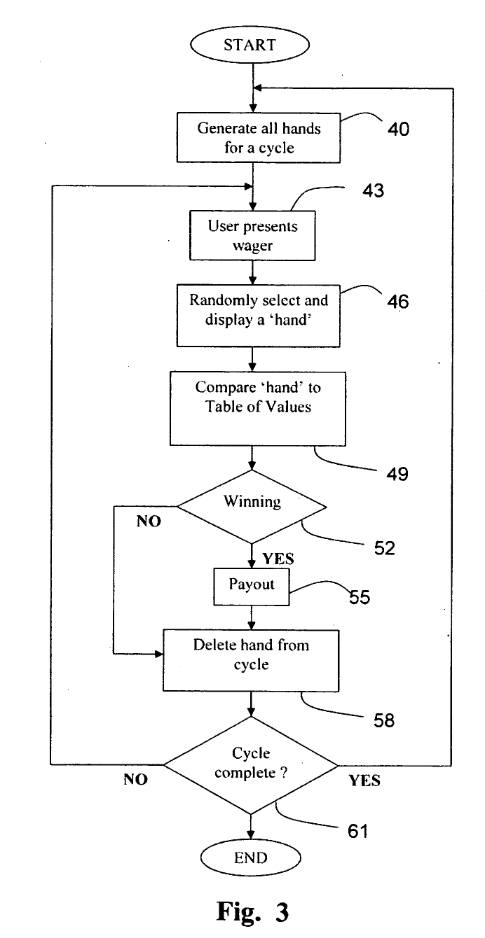

Referring to FIG. 3, a flow diagram is illustrated to show the logic of a control program that controls the operation of the game. FIG. 3 represents the sequence of steps establishing and carrying out a specific embodiment of the method of the invention. In general, play of the game involves determining and generating all the possible ‘hands’ for a cycle, causing the machine to display a ‘hand’ randomly selected from all possible hands, such ‘hand’ consisting of a plurality of elements, comparing such displayed ‘hand’ to a predetermined table of values, and determining a winning based on such comparison. Following such comparison, allowing play to continue until all possible ‘hands’ in the cycle have been displayed.

In the first step, at station 40, a game controller, preferably a software program, generates all possible ‘hands’ for a cycle based on the number of elements to be used for each ‘hand’ and the variety of elements from which to select. For example, in a first embodiment of the present invention, each ‘hand’ consists of five cards and each card in such ‘hand’ is selected from a separate deck of cards comprising the nine, ten, jack, queen, king, and ace of each of four suits. Using such five decks enables twenty-four cards for each element of such ‘hand’ and allows 5,100,480 unique ‘hands’ to be generated. Such generated ‘hands’ are stored in a database, such as in storage device 30.

At station 43, a player presents a wager, as an ante, which can include an administrative fee for management of the game as well as the “cost” to participate. For play of the game, the player inserts a quantitatively fixed wager for every game. (The apparatus for home game play enables selective determination if wagering is to be involved.) Payout for winning combinations may be dependent upon the amount of the wager. A minimum and maximum wager can be prescribed for each individual game.

In the next step, depicted at station 46, the game controller randomly selects one of the ‘hands’ from the database to be the player's ‘hand’. Such ‘hand’ is displayed on the gaming machine.

The next step, at 49, a game controller function of CPU 24 evaluates the elements displayed according to a predetermined table of values, to determine if a winning has occurred, at station 52. A player with a winning combination of elements is paid on his wager at station 55, according to the pay table of the game, such as shown in TABLE I.

The amount of available payout may depend on the amount of the wager. An example of a pay table for possible winning combinations is shown in TABLE I. With completion of a payout, if any, the round is complete and the player wins or loses more or less than that player's original wager, according to the game played.

After completion of this step, the controller deletes the played ‘hand’ from the database, station 58. After completion of this step, the player can decide whether to continue playing or to withdraw his or her winnings, if any.

If all the ‘hands’ in the database have been played, station 61, the game controller re-generates all the possible ‘hands’ for another cycle, otherwise play continues until all the ‘hands’ in the database have been shown and played.

The method disclosed herein can be played with an electronic video game machine that does not compete against the player. The steps and functions of a controller are established by software and take place electronically in video games to provide electronic indicia of playing elements, to maintain control of play of the game, and to sequence the steps of the game properly, while providing for selections made by a player. Such game controller is also responsible for collecting wagers that are lost and making payments to winners, according to the pay table. The electronic video game machine provides functions to generate all the possible ‘hands’ for a cycle, store such ‘hands’ in a database, and randomly select each ‘hand’ from such database until all ‘hands’ in the cycle have been used. Additional functions include displaying the indicia for each element, accepting selections by a player, and keeping control and order to the steps of the game. The electronic video game machine automatically collects the wagers from the losers and makes payments to the winners.

Fundamental concepts of a first embodiment of the invention are explained in relation to a preferred embodiment in an electronic video gaming machine based on playing a version of poker using five decks of cards having twenty-four cards per deck; that is, each deck has six elements with indicia representing 9, 10, J, Q, K, A of clubs, six elements with indicia representing 9, 10, J, Q, K, A of diamonds, six elements with indicia representing 9, 10, J, Q, K, A of hearts, and six elements with indicia representing 9, 10, J, Q, K, A of spades, inclusive are used for each of five decks. Each deck of twenty-four cards is used to select one element to make a five-card poker ‘hand’. Using such five decks of twenty-four cards enables 5,100,480 different unique hands.

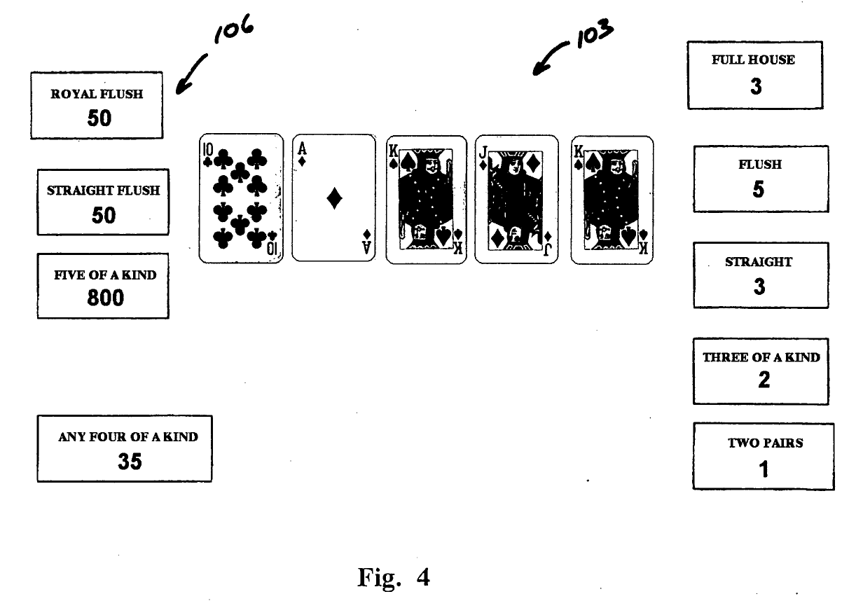

Referring now to FIG. 4, there is presented a video screen display 20 for an exemplary embodiment of the present invention. The display is sized to display a ‘hand’ 103 randomly selected from the database of all available hands. Indications of values of winning combination 106 may also be displayed. Additional player controls, described later herein, are implemented by displaying images on display screen 20, corresponding to controls on the screen such that when the control images are touched, the associated function is caused to be performed.

In the example shown in FIG. 4, the player's ‘hand’ contains a ten of clubs, an ace of diamonds, a king of spades, a jack of diamonds, and another king of spades. (Such duplication of the king of spades is possible since a separate deck is used to generate each card.) In the example of FIG. 4, the player doe not have a winning combination, as indicated in TABLE I (one pair is not a winning combination according to the pay table). If the combination had a winning value according to a predetermined table of values, such as TABLE I, the player would win a corresponding payout.

This completes the play of the displayed ‘hand’. The game controller removes the displayed ‘hand’ from the database and play continues. After completion of this step, the player can decide whether to continue playing or to withdraw his or her winnings, if any.

If the cycle of the database is not complete, in further play by the original player or a subsequent player the controller randomly selects a ‘hand’ to display from the remaining ‘hands’ in the database. Once the cycle is complete, all possible ‘hands’ are generated again to populate the database.

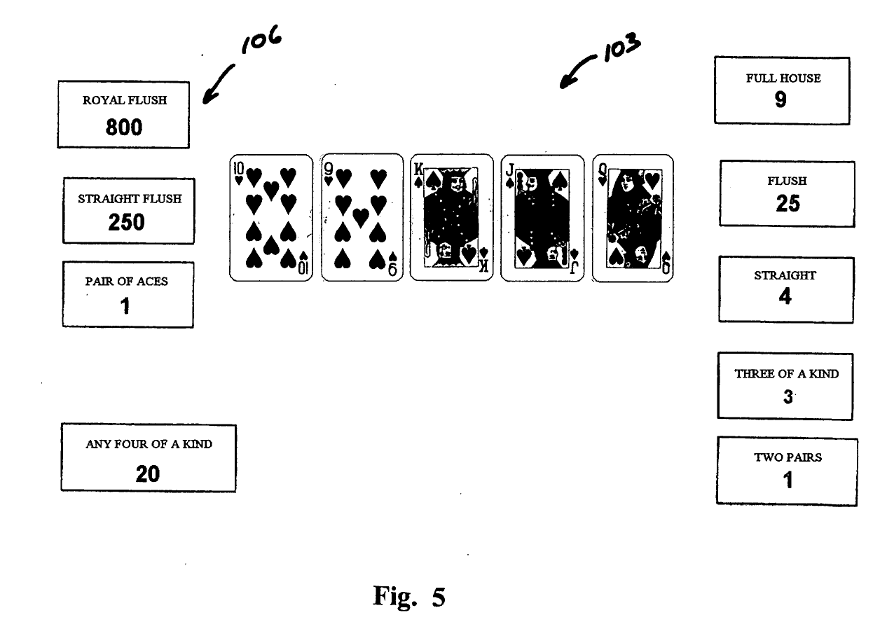

In an alternate embodiment, the concepts of the game can be embodied using a smaller deck of cards. For example, if only two colors of cards are utilized, such as only the hearts and spades, each deck would contain only twelve cards that is, each deck has six elements with indicia representing 9, 10, J, Q, K, A of a first color, such as red hearts and six elements with indicia representing 9, 10, J, Q, K, A of a second color, such as black spades, inclusive are used for each of five decks. Alternate suits may be used. Each deck of twelve cards is used to select one element to make a five-card poker ‘hand’. The database would contain only 248,832 different possible hands. A different table of values is used for variations of the game. FIG. 5 illustrates a video screen display for an alternate embodiment. In the example shown in FIG. 5, the player's ‘hand’ contains a ten of hearts, a nine of hearts, a king of spades, a jack of spades, and a queen of hearts. This is a winning combination as indicated in TABLE II. Since the combination has value according to a predetermined payout table of values, such as TABLE II, the player wins a payout corresponding to the combination of cards, as indicated on display screen 20. In this example, the winning combination is a straight.

In a further alternate embodiment, the concepts of the game can be embodied using a single deck of cards. For example, a single deck of twenty-four cards comprising four suits or a single deck of twelve cards comprising two suits or different colors.

In a further alternate embodiment, the player may select to play more than one ‘hand’. For each additional ‘hand’ played, an additional wager must be presented, in those embodiments in which wagering takes place. In some embodiments, each separate ‘hand’ may be selected from a separate database for its own cycle.

As can be seen from the description of the embodiments, the present invention is readily adaptable to play on a computer or video game. A person skilled in the art of computer and video game construction, as well as those skilled in other arts, will incorporate the method and conduct of this invention in such computer and video games.

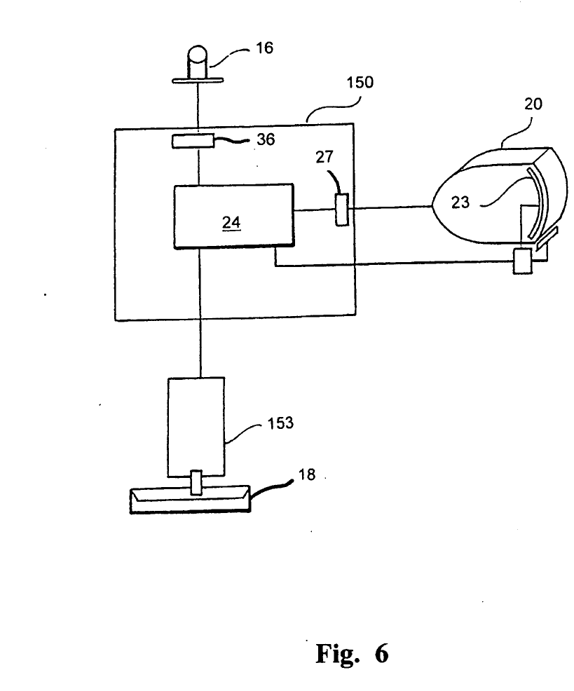

A program to implement the sequence of FIG. 3 can execute on a standard gaming machine as illustrated schematically in FIG. 6. CPU 24 forms part of slot machine controller 150 that drives the video screen display 20 and receives touch input signals from touch sensors 23 as well as receiving coin input pulses from coin sensor 36 and driving a coin payout mechanism 153.

In a preferred embodiment, a plurality of slot machine devices, as taught herein, can be connected to a central controller, which can be used to maintain a jackpot prize schedule for all devices in a network of devices. In this manner, several gaming establishments can combine to offer a single prize larger than any one establishment. Alternatively, each slot machine device can be adapted for maintaining a jackpot prize schedule for independent operation.

The invention has been described with reference to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art could modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

TABLE I
Relative Prize Value for Poker hands
(4 colors)

| | |
|---|---|
| Five of a Kind | 800 |
| Royal Flush | 50 |
| Straight Flush | 50 |
| Any Four of a Kind | 35 |
| Flush | 5 |
| Full House | 3 |
| Straight | 3 |
| Any Three of a Kind | 2 |
| Two Pairs | 1 |

TABLE II
Relative Prize Value for Poker hands
(2 colors)

| | |
|---|---|
| Royal Flush | 800 |
| Straight Flush | 250 |
| Any Four of a Kind | 20 |
| Flush | 25 |
| Full House | 9 |
| Straight | 4 |
| Any Three of a Kind | 3 |
| Two Pairs | 1 |
| One Pair of Aces | 1 |

What is claimed is:

1. Method of conducting a game, comprising
(A) providing a set of contest elements for said game in which said set includes a plurality of contest elements having a surface area with playing indicia on said surface area;
(B) generating all possible combinations of said contest elements and storing said combinations in a database;
(C) randomly selecting one combination of said contest elements from said database and displaying said selected combination to a player;
(D) establishing a table of values for winning combinations of contest elements;
(E) comparing said randomly selected elements to said table of values;
(F) evaluating the displayed combination of contest elements against said table of values; and
(G) deleting said displayed combination of contest elements from said database.

2. The method of claim 1, wherein said contest elements comprise twelve playing cards comprising:
9, 10, J, Q, K, and A of a black suit; and
9, 10, J, Q, K, and A of a red suit.

3. The method of claim 1, wherein said contest elements comprise twenty-four playing cards comprising:
9, 10, J, Q, K, and A of clubs;
9, 10, J, Q, K, and A of hearts;
9, 10, J, Q, K, and A of diamonds; and
9, 10, J, Q, K, and A spades.

4. The method of claim 1, wherein said combinations are determined for five card poker hands.

5. The method of claim 4, in which said combinations are selected using a separate deck for each card in said five card poker hand.

6. The method of claim 1, further comprising the steps of:
(H) re-generating all possible combinations of said contest elements and storing said combinations in a database after all combinations have been displayed to a player.

7. The method of claim 6, in which said game is played on a device selected from the group consisting of:
a) electronic video game machines;
b) computers;
c) hand-held mechanical devices; and
d) hand-held video devices.

8. The method of claim 6, further comprising the steps of:
(J) permitting said player to place a wager at the beginning of the game; and
(K) paying, the player having a winning combination of contest elements, as determined by the table of values according to the player's wager.

9. The method of claim 8, in which said game is played on a device selected from the group consisting of:
a) electronic video game machines;
b) computers;
c) hand-held mechanical devices; and
d) hand-held video devices.

10. A device for playing a game according to claim 1 selected from the group consisting of:
a) electronic video game machines;
b) computers;
c) hand-held mechanical devices; and
d) hand-held video devices.

11. A device for playing a game according to claim 8 selected from the group consisting of:
a) electronic video game machines;
b) computers;
c) hand-held mechanical devices; and
d) hand-held video devices.

12. A slot machine comprising:
(A) game initiating means to initiate a game on the machine;
(B) display means disposed to display the game being played on the machine wherein said display means is arranged to display a plurality of elements; and
(C) game control means responsive to the initiating means to control the playing of the game, wherein the control means generates all combinations of said plurality of elements and stores said combinations in a database, said control means randomly selects one said combination from said database for display to a player, said control means compares said selected combination to a table of values to determine if a winning combination is displayed, and awarding a prize to the player in the event that said randomly selected combination matches a winning combination from said table of values, then said control means deleting said displayed combination from said database, said game control means re-generating all combinations of said plurality of elements after all combinations have been displayed.

13. The slot machine of claim 14, further comprising means for a player to wager on the displayed combination of elements.

14. An electronic system for playing a slot machine game having a plurality of play options wherein a win or a loss is determined after each play of the game, the system comprising:
(A) a game enclosure, the enclosure including a player interface means for at least one player to physically interact with the system;
(B) bet value entry means for generating a bet value signal to the system, the bet value signal representing an amount of a bet placed by a player;
(C) processor means for determining all possible combinations of elements for the game being played;
(D) means for storing said combinations in a database;
(E) game control means to randomly select a combination of elements from said database;
(F) player display means for visually indicating to the player said randomly selected combination; and
(G) processor means for comparing said selected combination to a predetermined table of values and awarding a prize to the player in the event that said randomly selected combination matches a winning combination on said table of values, then deleting said combination from said database, the processor means being electrically connected to the player display means, to the player selection means, to the bet value entry means, and to the game control means.
